(19) United States
(12) Patent Application Publication
(10) Pub. No.: US 2016/0284328 A1
(43) Pub. Date: Sep. 29, 2016

(54) Hi-Hat Controller to Control Cymbals

(71) Applicant: James Sera, Cambridge (CA)

(72) Inventor: James Sera, Cambridge (CA)

(21) Appl. No.: 14/794,458

(22) Filed: Jul. 8, 2015

Related U.S. Application Data
(60) Provisional application No. 62/138,415, filed on Mar. 26, 2015.

(51) Int. Cl. G10D 13/06

(52) U.S. Cl. CPC G10D 13/065

(57) ABSTRACT

A hi-hat controller for controlling a space between a lower hi-hat cymbal and an upper hi-hat cymbal includes a first body portion for coupling to the lower hi-hat cymbal, a second body portion for coupling to a cymbal stand, an actuator for moving the first body portion relative to the second body portion through a range of motion to adjust the space between the lower and upper hi-hat cymbals, and a lock that automatically fixes the position of the first body portion with respect to the second body portion at any position along the range of motion when a user releases the actuator.

### TECHNICAL FIELD

The embodiments disclosed herein relate to musical instruments, and, in particular to devices for controlling percussion instruments.

### INTRODUCTION

The following paragraphs are not an admission that anything discussed in them is prior art or part of the knowledge of persons skilled in the art.

The disclosure relates to a hi-hat stand and the cymbals on it, used commonly in a drum set. The hi-hat stand holds two cymbals which can be closed and opened with the user's foot generating a sound with the cymbals. The foot can also change the sound of the cymbals when the user is hitting them by changing the spacing between the cymbals.

Having to use the foot to control the hi-hat may limit the user's ability to use that foot for other items, such as double bass pedals, or resting that foot. Also, when using the foot for something other than the hi-hat, conventionally the user cannot adjust the hi-hat until placing their foot onto the hi-hat pedal. Conventionally, the user will stop what they are doing with that foot and return to the hi-hat which may be undesirable.

U.S. Pat. No. 8,692,098 to Reinhard describes a leg lever adjustment device for a hi-hat musical instrument. The leg lever moves the lower cymbal up and down based on a user's lateral leg movement. When the leg lever is in its rest position, the lower cymbal is pushed upwardly by a spring toward or against the upper cymbal. When a user presses the leg lever with a leg, this moves the lower cymbal down and away from said upper cymbal. Where the user releases the leg lever, the cymbal returns to the resting position. There is a latch receiver to deactivate the adjustment device and render the device inoperable. To reactivate the device, the user hits the top of the latch with a drumstick to release the latch.

U.S. Patent Application Publication No. 2004/0103775 to Vergara describes a pedal free cymbal device that has a lever mechanism to pivotably bring a lower cymbal upwards to a top cymbal. The lower cymbal is held down by a spring when the lever mechanism is not being held by the user. If the user desires to keep the cymbals closed, the lever is held closed by the user.

U.S. Pat. No. 5,367,939 to Barker describes a hand held cymbal device for use with one hand. The device includes a trigger mechanism for displacing a moveable cymbal relative to a fixed cymbal. The cymbals may be urged apart from one another by a spring. When the trigger mechanism is released, the cymbals return to the open position.

While there are a number of cymbal devices, they may not provide the use and ability that may be desired by a user. For example, when released the conventional devices may retract to a resting position.

### SUMMARY

According to some embodiments, there is a hi-hat controller for controlling a space between a lower hi-hat cymbal and an upper hi-hat cymbal. The controller includes a first body portion for coupling to the lower hi-hat cymbal, a second body portion for coupling to a cymbal stand, an actuator for moving the first body portion relative to the second body portion through a range of motion to adjust the space between the lower hi-hat cymbal and the upper hi-hat cymbal, and a lock that automatically fixes the position of the first body portion with respect to the second body portion at any position along the range of motion when a user releases the actuator.

According to some embodiments, the actuator includes a handle attached to the first body portion and rotatable with respect to the second body portion, wherein the handle engages in a slot in the first body portion to move the first body portion.

According to some embodiments, the lock includes a friction fit lock to hold the first body portion at the fixed position.

According to some embodiments, the actuator includes an adjustment arm mounted to and rotatably attached to the second body portion, a first gear attached to the adjustment arm, and a second gear mounted to and rotatably attached to the second body portion. The first gear rotatably engages the second gear and the second gear rotatably engages with a rack on the first body portion to move the first body portion.

According to some embodiments, the lock includes a threaded fastener in the second body portion, a spring mounted to the threaded fastener, and a friction body mounted to the spring. The friction body provides friction to any one or more of the first gear, the second gear, and the first body portion to fix the position of the first body portion.

According to some embodiments, the actuator includes an adjustment arm rotatably attached to the second body portion and engaging with a cavity in the first body portion. Movement of the adjustment arm moves the first body portion.

According to some embodiments, the lock includes a lock bolt for compressing the second body portion around the first body portion to adjust the friction between the first body portion and the second body portion to hold the position of the first body portion.

According to some embodiments, the adjustment arm includes a grooved stop to engage on the cavity to hold the lower hi-hat cymbal at an upmost position.

According to some embodiments, the actuator includes an adjustment arm rotatably attached to the second body portion and having a geared surface. The geared surface mates with a rack gear on the first body portion.

According to some embodiments, the lock includes a lever rotatably attached to the adjustment arm. The lever includes a ratchet point biased against ratchet notches in the second body portion. The ratchet notches and the ratchet point inhibit movement of the first body portion.

According to some embodiments, the actuator includes an adjustment arm rotatably attached to the second body portion, the adjustment arm having a pivot pin, and a wedge slidably received in the second body portion, the wedge having an angled surface and a pivot slot for receiving the pivot pin. The pivot pin moves in the pivot slot to move the wedge laterally in the second body portion. The angled surface of the wedge slides on an angled surface of the first body portion to move the first body portion.

According to some embodiments, the angled surface of the wedge frictionally engages with the angled surface of the first body portion to set the position of the first body portion.

According to some embodiments, the actuator includes a cable actuator for moving the first body portion with respect to the second body portion, and a remote control for triggering the cable remotely from the hi-hat.

According to some embodiments, the actuator further includes a housing arm rotatably attached to the second body portion for moving the first body portion, a cable attached at a first end to the housing arm and passing through an extension arm, a spring in the second body portion for biasing the housing arm when the cable is loosened, a ratchet wheel rotatably attached to the remote control and attached to a second end of the cable, and a hinged arm attached to the ratchet wheel for controlling the ratchet wheel. When the user actuates the hinged arm, the hinged arm pulls the cable around the ratchet wheel and pivots the housing arm to move the first body portion.

According to some embodiments, the lock includes a lock arm biased to the ratchet wheel for inhibiting movement of the ratchet wheel.

According to some embodiments, the lock includes a locking cam for tightening the cable when the extension arm is pivoted with respect to the second body portion.

According to some embodiments, the lock includes a ratchet arm rotatably attached to the second body portion and a plurality of ratchet grooves on the first body portion. The plurality of ratchet grooves interact with the ratchet arm to set the position of the first body portion.

According to some embodiments, the lock comprises at least one friction screw mounted in the second body portion, a spring mounted to the friction screw in the second body portion, and a friction body mounted to the spring. The friction body provides frictional force to any one or more of the first body portion, the adjustment arm, or the second body portion to set the position of the first body portion.

According to some embodiments, the lock includes a threaded fastener mounted in the adjustment arm for tightening the adjustment arm around a lock bolt to set the friction to hold the position of the first body portion. The lock bolt is fixed in the second body portion and inhibited from rotating axially.

According to some embodiments, the lock includes a lock bolt mounted and axially fixed in the second body portion, an expanding sleeve on the lock bolt operable to expand, and a nut on the lock bolt, which when tightened, expands the expanding sleeve. The expanding sleeve expands on the adjustment arm to set the friction to hold the position of the first body portion.

According to some embodiments, the lock includes a threaded fastener for tightening the second body portion around a lock bolt to set the friction to hold the position of the first body portion. The lock bolt is integral and moves with the adjustment arm.

According to some embodiments, the lock includes a lock bolt integral with the adjustment arm, an expanding sleeve on the lock bolt and operable to expand, and a nut on the lock bolt, which when tightened, expands the expanding sleeve. Wherein the expanding sleeve expands on the second body portion to set the friction to hold the position of the first body portion.

According to some embodiments, the lock includes a lock bolt for compressing the second body portion around the adjustment arm to adjust the friction between the first body portion and the adjustment arm to hold the position of the first body portion.

According to some embodiments, the lock includes a threaded fastener and a nut for compressing the nut against the adjustment arm to adjust the friction between the nut and the adjustment arm to hold the position of the first body portion.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 illustrates a side view of a conventional hi-hat assembly;

FIG. 2 illustrates a schematic of a hi-hat assembly having a hi-hat controller, in accordance with an embodiment;

FIGS. 3A and 3B illustrate a perspective view and an exploded view of a hi-hat controller having a spiral actuator, in accordance with an embodiment;

FIGS. 4A to 4E illustrate a perspective side view, an exploded view, a top view, a section view along 4D-4D of FIG. 4C, and a section view along 4E-4E of FIG. 4C of a hi-hat controller having a gear actuator, in accordance with an embodiment;

FIGS. 5A to 5F illustrate a side view, a section view, a detailed section view, a top view, a section view along 5E-5E of FIG. 5D, and a detailed view of a hi-hat controller having a pivot rod actuator, in accordance with an embodiment;

FIGS. 6A to 6D illustrate a perspective view, an exploded view, a side view, and a detailed view of a hi-hat controller having a gear rod actuator, in accordance with an embodiment;

FIGS. 7A to 7C illustrate a perspective view, a side view, and a detailed view of a hi-hat controller having a wedge rod actuator, in accordance with an embodiment;

FIGS. 8A to 8K illustrate a perspective view, a rotated perspective view, a detailed view, a top perspective view, a lower detailed view, a lower exploded view, a lower detailed view, a perspective view, a lower side view, a detailed view, and a lower sectional view of a hi-hat controller having a cable actuator, in accordance with an embodiment;

FIG. 9 illustrates a perspective view of a hi-hat controller having a cable actuator in use with a hand and a drumstick, in accordance with an embodiment;

FIGS. 10A and 10B illustrate a perspective view and a side section view of a hi-hat controller having an alternative cable actuator, in accordance with an embodiment; and

FIGS. 11A to 11F illustrate detailed views of a ratchet lock, a friction fastener lock, a pivot fastener lock, an expanding sleeve lock, a housing fastener lock, and another expanding sleeve lock for hi-hat controllers, respectively, in accordance with certain embodiments.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below. It is possible that an apparatus or process described below is not covered by any of the claimed embodiments. Any embodiment disclosed below that is not claimed in this document may be the subject matter of another protective instrument, for example, a continuing patent application, and the applicants, inventors or owners do not intend to abandon, disclaim or dedicate to the public any such embodiment by its disclosure in this document.

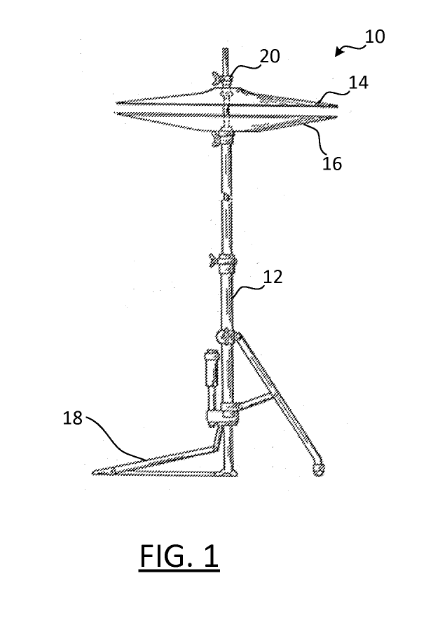

Referring to FIG. 1, illustrated therein is a hi-hat assembly 10, as may be known in the art. The hi-hat assembly 10 includes a stand 12 that supports an upper cymbal 14 and a lower cymbal 16. The hi-hat assembly 10 includes a pedal 18 which controls the movement of the upper cymbal 14 with respect to the lower cymbal 16. The upper cymbal 14 is fixed to and remains stationary with respect to a rod 20. The upper cymbal 14 is adjustable in height with respect to the rod 20 by a conventional clutch, as known in the art. The upper cymbal 14 may be adjusted based on how much the user wants to step on the pedal 18. The lower cymbal 16 rests on and is supported by the stand 12. There may be a dampening pad (not shown) between the lower cymbal 16 and the stand 12 to dampen noise and vibrations.

Conventionally, as the pedal 18 is pressed down, the rod 20 pulls the upper cymbal 14 down and closes the upper cymbal 14 onto the lower cymbal 16. For example, a user may step on the pedal 18 to clash the upper and lower cymbals 14, 16 together. The upper cymbal 14 is biased up. When the pedal 18 is released, the upper cymbal 14 is raised to open a space between the upper and lower cymbals 14, 16. Further, a user can vary the distance between the upper cymbal 14 and the lower cymbal 16 using the pedal 18 to produce varying sounds when the upper and lower cymbals 14, 16 are struck by a drumstick.

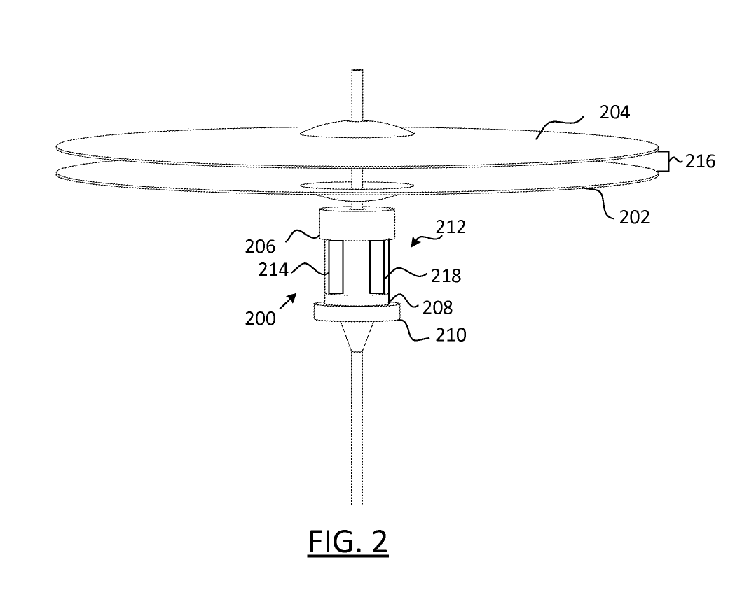

For the sake of clarity, in FIGS. 2 through 11, only the upper portion of the hi-hat assembly (e.g. hi-hat assembly 10) is shown.

FIG. 2 illustrates a hi-hat controller 200, in accordance with an embodiment. The hi-hat controller 200 controls the position of a lower hi-hat cymbal 202 with respect to an upper hi-hat cymbal 204. The hi-hat controller 200 mounts between a stand 210 (e.g. stand 12) and the lower hi-hat cymbal 202. The hi-hat controller 200 includes a first body portion 206 (e.g. a shaft) for coupling to the lower hi-hat cymbal 202 and a second body portion 208 (e.g. a housing) for coupling to the stand 210. The lower hi-hat cymbal 202 moves with the first body portion 206. The second body portion 208 remains stationary with respect to the stand 210. The first body portion 206 and the second body portion 208 have openings therein for the rod (e.g. rod 20) to pass through. The hi-hat controller 200 may also include a dampening pad (not shown) between the lower cymbal 202 and the first body portion 206 to dampen noise and vibrations.

The hi-hat controller 200 includes an actuator 212 for moving the first body portion 206 relative to the second body portion 208 through a range of motion to adjust a space 216 between the lower and upper hi-hat cymbals 202, 204. The first body portion 206 moves the lower hi-hat cymbal 202 with respect to the upper hi-hat cymbal 204 through the range of motion.

In an embodiment, the hi-hat controller includes a lock 214 for fixing the position of the first body portion 206 with respect to the second body portion 208 at any position along the range of motion. The lock 214 may automatically set the position of the first body portion 206 such that further user intervention is not required to prevent further movement of the first body portion 206. The lock 214 and the actuator 212 may maintain the position of the lower cymbal 202 throughout the range of motion, even where the user releases the actuator 212 or where the actuator 212 is not engaged by the user. When the actuator 212 is released by a user, the first body portion 206 remains in the set position with respect to the second body portion 208.

The hi-hat controller 200 allows the lower hi-hat cymbal 202 to be lifted as desired by the user. The space 216 between the lower hi-hat cymbal 202 and the upper hi-hat cymbal 204 is adjusted by hand using the hi-hat controller 200 without the use of the user's foot or foot pedal (e.g. pedal 18). In an embodiment, where the user presses on the foot pedal with an increased force, the upper hi-hat cymbal 204 presses down on the lower hi-hat cymbal 202 to lower the first body portion 206.

The hi-hat controller 200 may be an add-on to the hi-hat assembly that allows the user to control the opening of the hi-hat cymbals 202, 204 with or without the use of their foot. Alternatively, the hi-hat controller 200 may be integrally assembled with the hi-hat cymbal.

When the hi-hat controller 200 is in use, the user uses their hand and/or the drumstick to control the actuator 212 and thus the opening and closing of the hi-hat cymbals 202, 204. Once the user finds a desirable opening of the cymbals 202, 204, the lock 214 keeps the cymbals 202, 204 in that position, until the lock 214 is disengaged. The actuator 212 may disengage the lock 214. For example, when the actuator 212 is re-engaged by the user, the force of the lock 214 is overcome and the user can again adjust the height of the lower cymbal 202. When the height of the first body portion 206 is locked or set, the user does not need to actively keep the cymbals 202, 204 in the set position. In an embodiment, the user can hit other items (drums, cymbals, etc.) with their drumstick while controlling the hi-hat opening space 216 with the same hand holding the drumstick.

In an embodiment, the lock 214 may set the spacing of the lower and upper hi-hat cymbal 202, 204, at any position as desired by the user. The lower cymbal 202 may be positioned at a fully open position, a fully closed position, and anywhere in between. The lock 214 provides that the lower cymbal 202 is not biased in any direction (for example, downward due to gravity), and the actuator 212 provides a full range of positions for the lower cymbal 202.

In an embodiment, the user can adjust both the lower cymbal 202 with the actuator 212 and the upper cymbal 204 with the pedal.

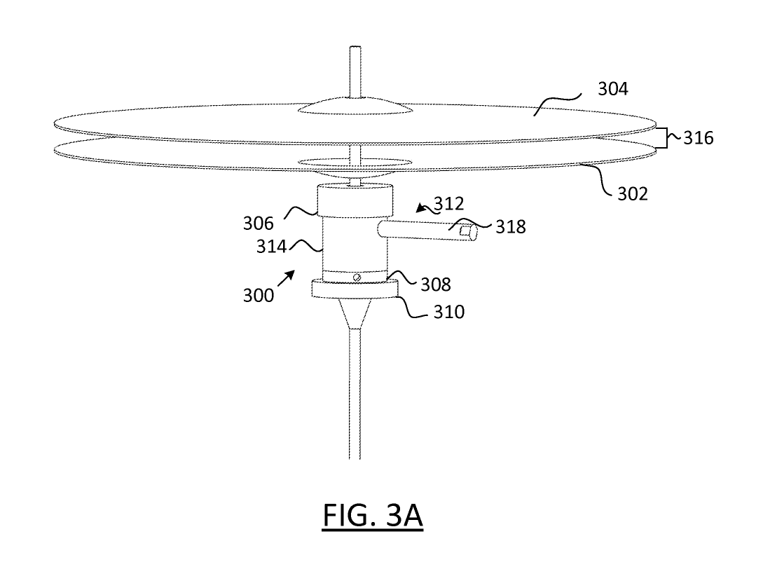

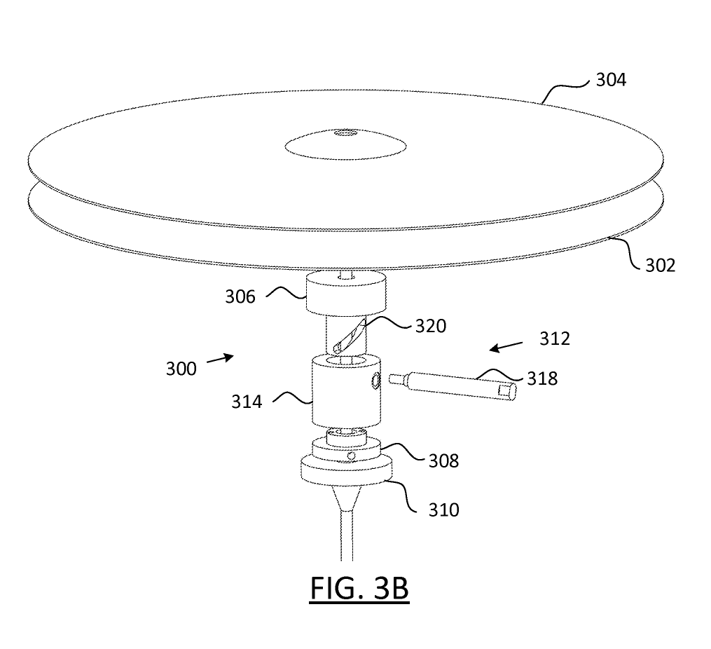

FIGS. 3A and 3B illustrate a hi-hat controller 300 having a spiral actuator 312, in accordance with an embodiment. The hi-hat controller 300 includes a housing 308 (e.g. second body) that attaches to the stand 310 and a shaft 306 (e.g. first body) that moves the shaft 306 up and down, to adjust the space 316 between a lower cymbal 302 and an upper cymbal 304.

The spiral actuator 312 includes a handle 318 that attaches to the shaft 306 and rotates with respect to the housing 308. The handle 318 engages in a slot 320 of the shaft 306 to move the shaft 306 up and down. The housing 308 does not rotate with respect to the stand 310. The shaft 306 does not rotate. The shaft 306 is axially locked to the housing 308 and moves up and down. The spiral actuator 312 may be at an angle selected to inhibit movement of the shaft 306 and that may be overcome when the handle 318 is adjusted by the user.

The spiral actuator 312 includes a friction fit lock 314 to hold the shaft 306 at a set position to inhibit the shaft 306 from sliding down from gravity. The friction fit lock 314 provides frictional forces to the shaft 306 to inhibit movement of the shaft 306 which may be overcome by movement of the handle 318.

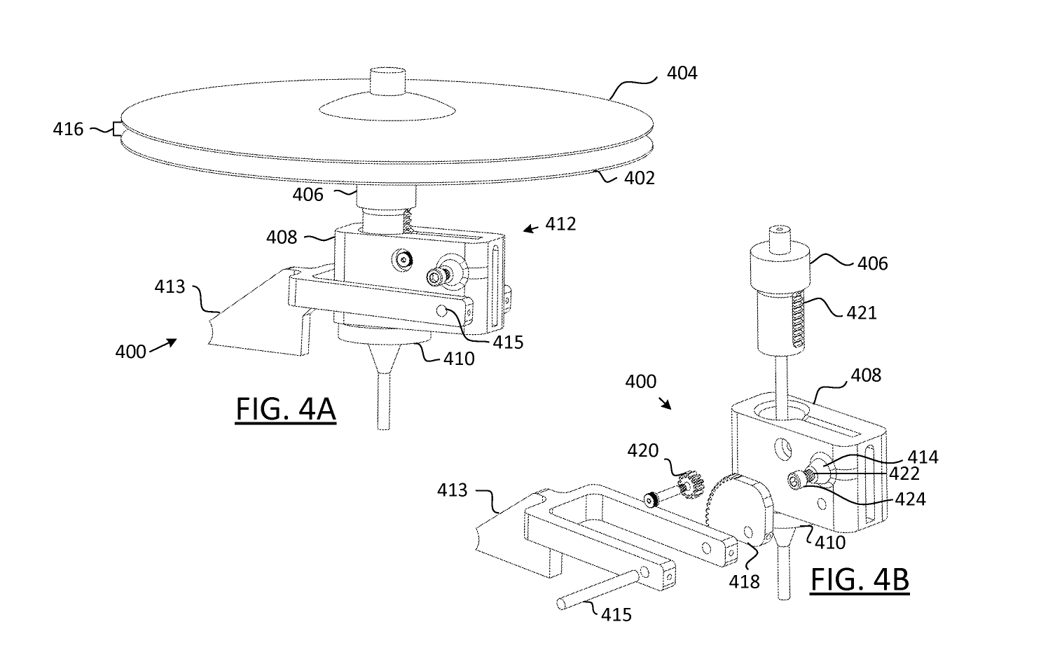

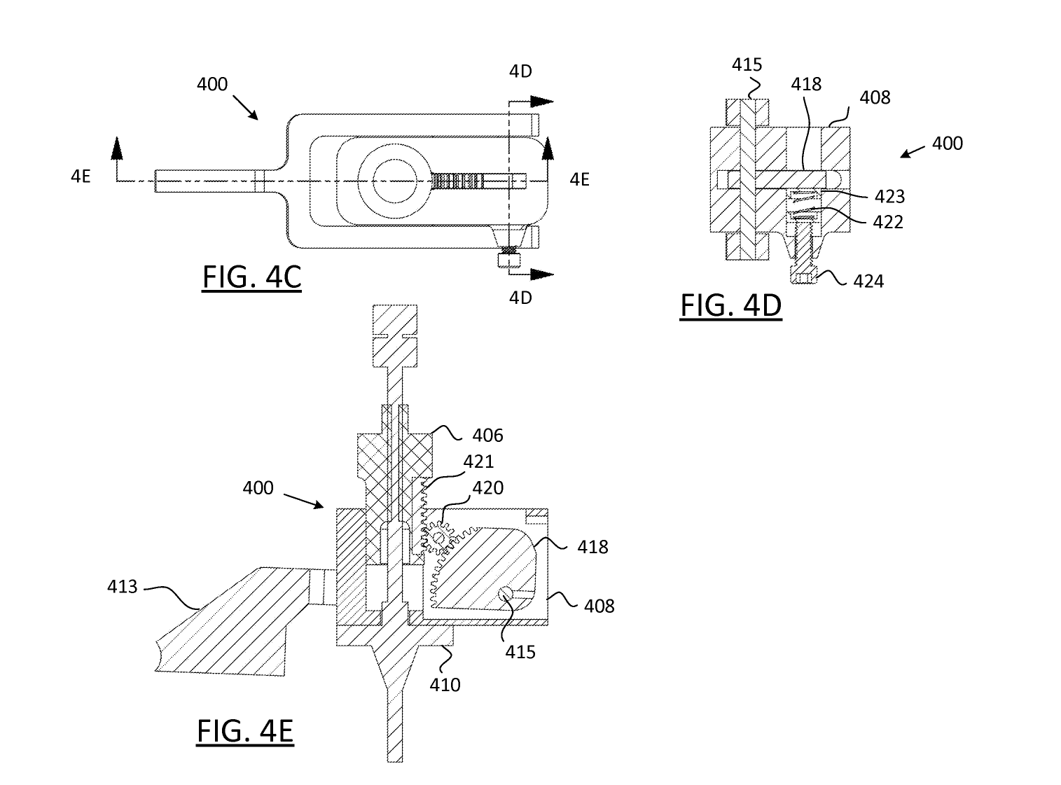

FIGS. 4A to 4E illustrate a hi-hat controller 400 having a gear actuator 412, in accordance with an embodiment. The hi-hat controller 400 includes a housing 408 (e.g. second body) that attaches to a stand 410.

The gear actuator 412 includes an adjustment arm 413 mounted to and rotatably attached to the housing 408. The adjustment arm 413 rotates a first gear 418 mounted in the housing 408. The first gear 418 is rotatably mounted in the housing 408 and attached to the adjustment arm 413. The first gear 418 meshes with and rotates a second gear 420. The second gear 420 meshes with a rack 421 on a shaft 406 (e.g. first body). When the second gear 420 rotates on the rack 421, the shaft 406 moves up and down to adjust a space 416 between a lower hi-hat cymbal 402 and an upper hi-hat cymbal 404.

The adjustment arm 413 pivots about a rod 415 in the housing 408. In an embodiment, the second gear 420 is smaller than the first gear 418 so that a small force in the adjustment arm 413 may have the desired holding force on the shaft 406. The holding force may inhibit movement of the shaft 406 that may be overcome by movement of the adjustment arm 413 by the user.

The hi-hat controller 400 includes a friction plate lock 414 to set the shaft 406 in position such that the height of the shaft 406 is adjustable by the adjustment arm 413. The friction plate lock 414 includes a threaded fastener 424 such as a screw in the housing 408 pushing on a spring 422 which pushed on a friction body 423. The friction body 423 provides friction on the first gear 418 to set the position of the shaft 406. When the threaded fastener 242 is adjusted, the friction on the first gear 418 is adjusted such that the appropriate friction force is exerted on the first gear 418 to provide a desired fixing strength. In certain embodiments, the friction body 423 may be positioned to provide friction on the first gear 418, the second gear 420, and/or the shaft 406.

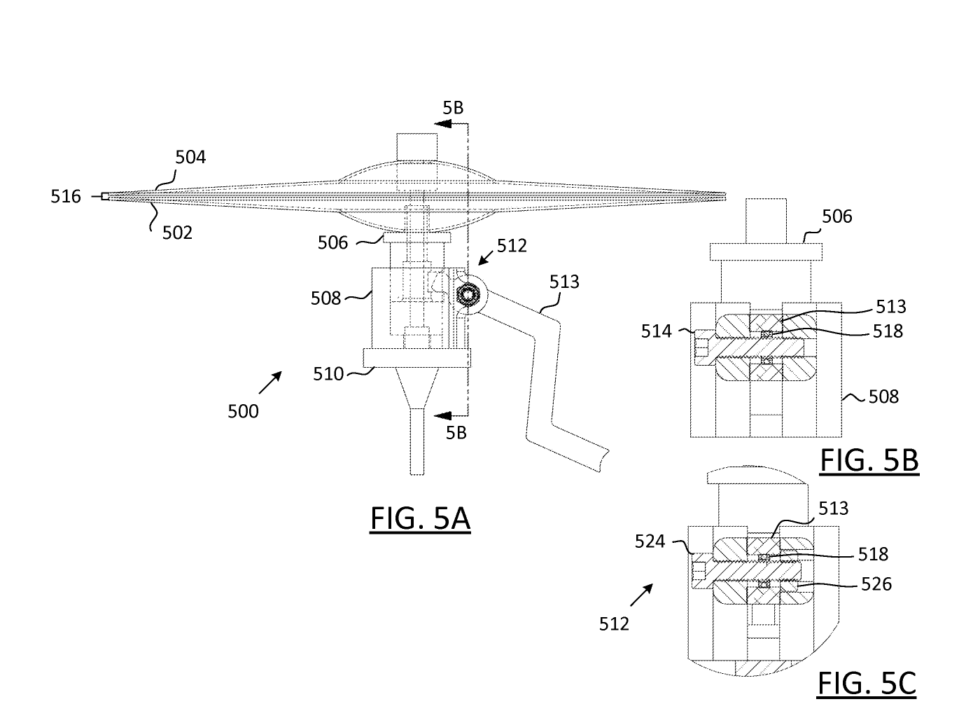

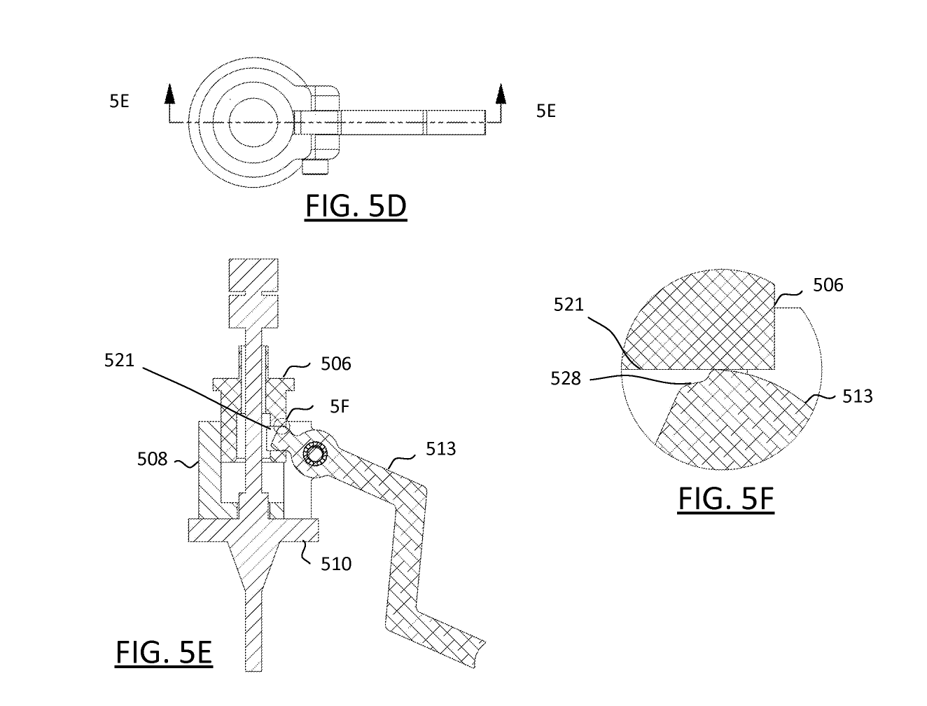

FIGS. 5A to 5F illustrate a hi-hat controller 500 having a pivot rod actuator 512, in accordance with an embodiment. The hi-hat controller 500 includes a housing 508 (e.g. second body) that attaches to a hi-hat stand 510. The pivot rod actuator 512 includes an adjustment arm 513 rotatably attached to the housing 508 and engaged with a cavity 521 in a shaft 506 (e.g. first body). Movement of the adjustment arm 513 moves the shaft 506 up and down to adjust a space 516 between a lower hi-hat cymbal 502 and an upper hi-hat cymbal 504 as desired by the user.

The adjustment arm 513 pivots on a bearing 518 attached to a lock bolt 514. The lock bolt 514 can be tightened by the user to squeeze the housing 508 together to increase the friction on the adjustment arm 513 as illustrated at FIG. 5B. The lock bolt 514 can set or hold the shaft 506 at the space 516 as set by adjustment arm 513. When the adjustment arm 513 is pivoted by the user, the extended length of the adjustment arm 513 may provide the friction caused by the lock bolt 514 to be overcome to move the shaft 506. The friction caused by the lock bolt 514 is such that, when there is no movement of the adjustment arm 513, the position of the lower hi-hat cymbal 504 is fixed and there is no movement of the shaft 506. In an embodiment, the adjustment arm 513 pivots on the bearing 518 attached to the lock bolt 514 to reduce friction on the lock bolt 514 from the adjustment arm 513 such that movement of the adjustment arm 513 does not loosen or tighten the lock bolt 514.

In an embodiment, the lock bolt 514 has a tight tolerance in the housing 508. When the lock bolt 514 is tightened, the housing 508 tightens around the shaft 506 instead of the adjustment arm 513. The lock bolt 514 adjusts the friction between the shaft 506 and the housing 508 to lock the space 516 between the lower hi-hat cymbal 502 and the upper hi-hat cymbal 504.

In an embodiment, as illustrated at FIG. 5C, the pivot rod actuator 512 includes a threaded fastener 524, which when tightened, pulls a nut 526 against the adjustment arm 513 tightening the adjustment arm 513. The nut 526 shape is profiled into the housing 508 such that the nut 526 can move in and out and is inhibited from rotating. The bearing 518 pivots around the threaded fastener 524 to inhibit the threaded fastener 524 from loosening or tightening when the adjustment arm 513 is adjusted by the user.

In an embodiment, as shown in FIG. 5F, the adjustment arm 513 includes a grooved stop 528 at a point where the grooved stop 528 engage in the cavity 521 where the lower cymbal 502 is in an upmost position. The grooved stop 528 holds the lower hi-hat cymbal 502 at an upmost position where the holding force may be more desirable. The grooved stop 528 may provide extra holding force when the lower hi-hat cymbal 502 and the upper hi-hat cymbal 504 are being squeezed together at the upmost position.

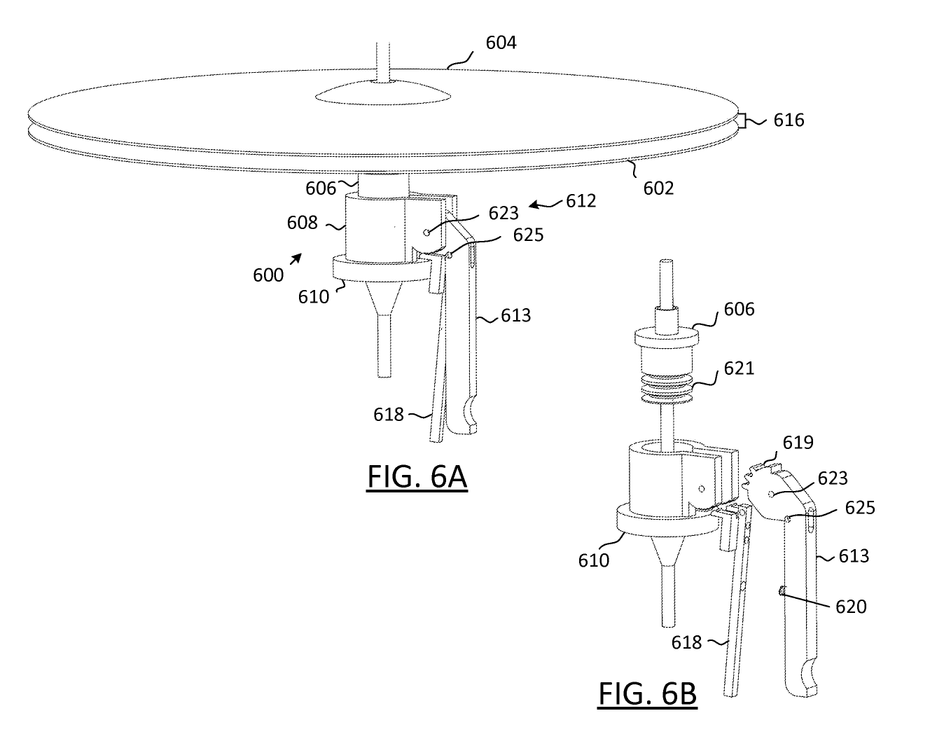

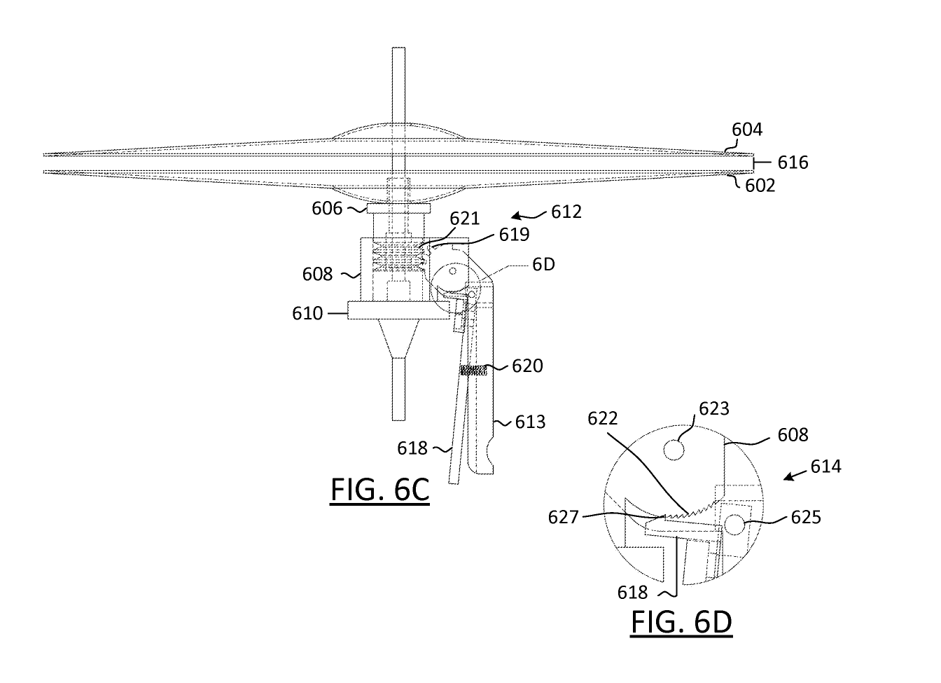

FIGS. 6A-6D illustrate a hi-hat controller 600 having a gear rod actuator 612, in accordance with an embodiment. The hi-hat controller 600 includes a housing 608 (e.g. second body) that attaches to a stand 610. The gear rod actuator 612 pivots in the housing 608 and moves a shaft 606 (e.g. first body) up and down, to adjust a spacing 616 between a lower hi-hat cymbal 602 and an upper hi-hat cymbal 604 as desired by the user.

The gear rod actuator 612 includes an adjustment arm 613 rotatably attached to the housing 608. The adjustment arm 613 has a geared surface 619 that mates with a rack gear 621 on the shaft 606. When the adjustment arm 613 is pivoted about adjustment pivot 623, the geared surface 619 engages with the rack gear 621 to raise and lower the shaft 606.

The hi-hat controller 600 includes a lock 614 rotatably attached to the adjustment arm 613. The lock 614 includes a lever 618 which pivots about the adjustment pivot 623 in the adjustment arm 613. The lever 618 includes a ratchet point 627 that is biased by a spring 620 against ratchet notches 622 in the housing 608. The ratchet notches 622 and ratchet point 627 set the adjustment arm 613 in place to inhibit movement of the shaft 606. The ratchet notches 622 and ratchet point 627 may inhibit movement of the adjustment arm 613 in one direction. For example, the lock 614 stops the shaft 606 from being lowered but allows for the shaft 606 to be raised by the user, while the lock 614 is engaged. The ratchet notches 622 and the ratchet point 627 may be on one or more places on the housing 608.

When a user presses the lever 618, the lever 618 unlocks the adjustment arm 613 from the ratchet notches 622 and allows the shaft 606 to be lowered.

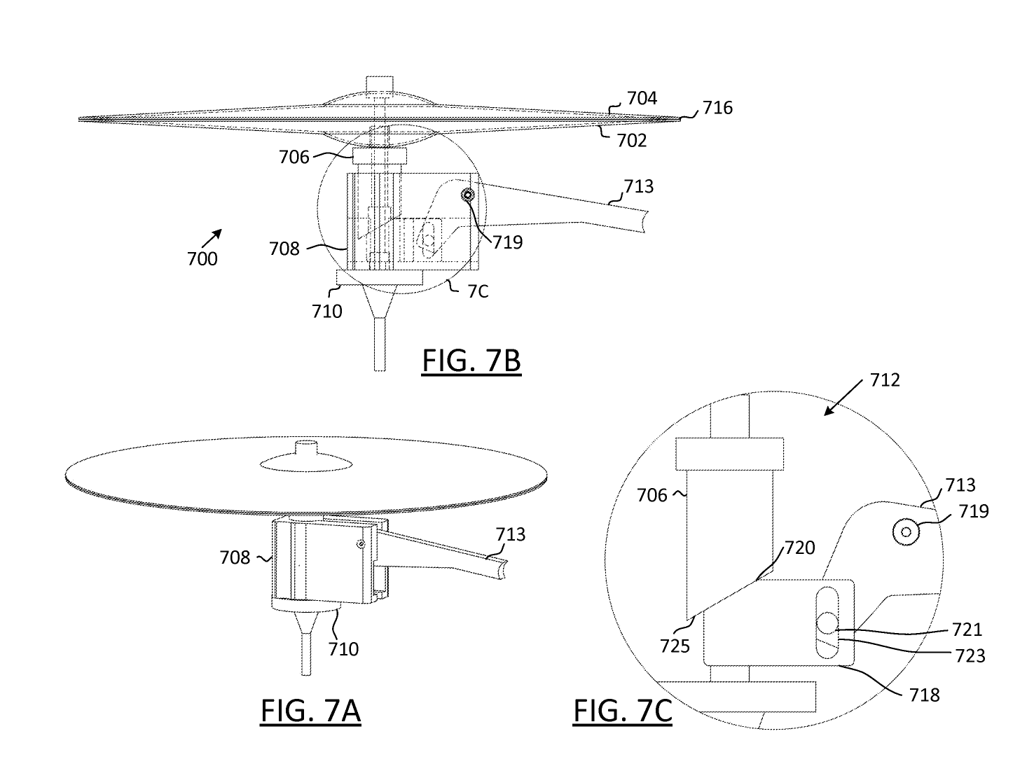

FIGS. 7A to 7C illustrate a hi-hat controller 700 having a wedge rod actuator 712, in accordance with an embodiment. The hi-hat controller 700 includes a housing 708 (e.g. second body) that attaches to a hi-hat stand 710. The wedge rod actuator 712 includes an adjustment arm 713 rotatably attached to the housing 708. The adjustment arm 713 pivots about arm pivot 719 in the housing 708.

The adjustment arm 713 includes a pivot pin 721 that moves up and down in a pivot slot 723 in a wedge 718 as the adjustment arm 713 moves. The wedge 718 is slidably received in the housing 708. The wedge 718 has an angled surface at one end and the pivot slot 723 at an opposite end. As the pivot pin 721 moves in the pivot slot 723, the wedge 718 moves laterally in the housing 708 (e.g. left and right in FIGS. 7B and 7C). The lateral movement of the wedge 718 causes the angled surface of the wedge 718 to slide on an angled surface 725 of a shaft 706 (e.g. first body) to move the shaft 706 up and down to adjust a space 716 between a lower hi-hat cymbal 702 and an upper hi-hat cymbal 704 as desired by the user.

The hi-hat controller 700 may include a lock to set the position of the shaft 706. In an embodiment, the angled surface of the wedge 718 frictionally engages with the angled surface of the shaft 706 to set the position of the shaft 706. The degree of the angle 720 and the frictional surface of the angled surfaces may be selected such that the shaft 706 is fixed in position when the wedge rod actuator 712 is released by the user.

In an embodiment, where increased fixing force is desired, the lock may include a fastener 714 that, when tightened, compresses the housing 708 to provide friction on any one or more of the wedge 718, the adjustment arm 713, and the shaft 706.

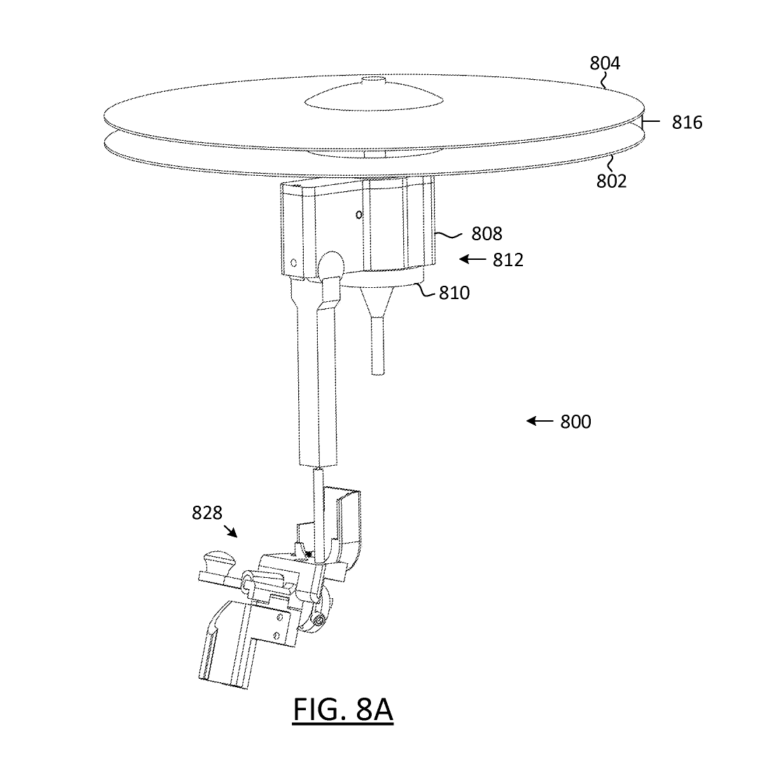

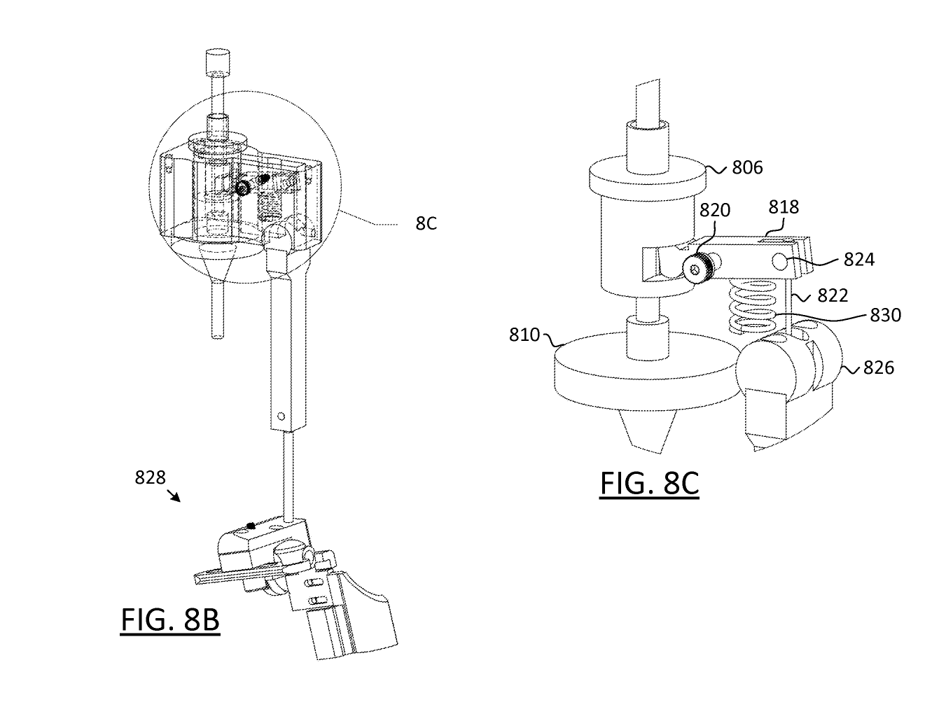

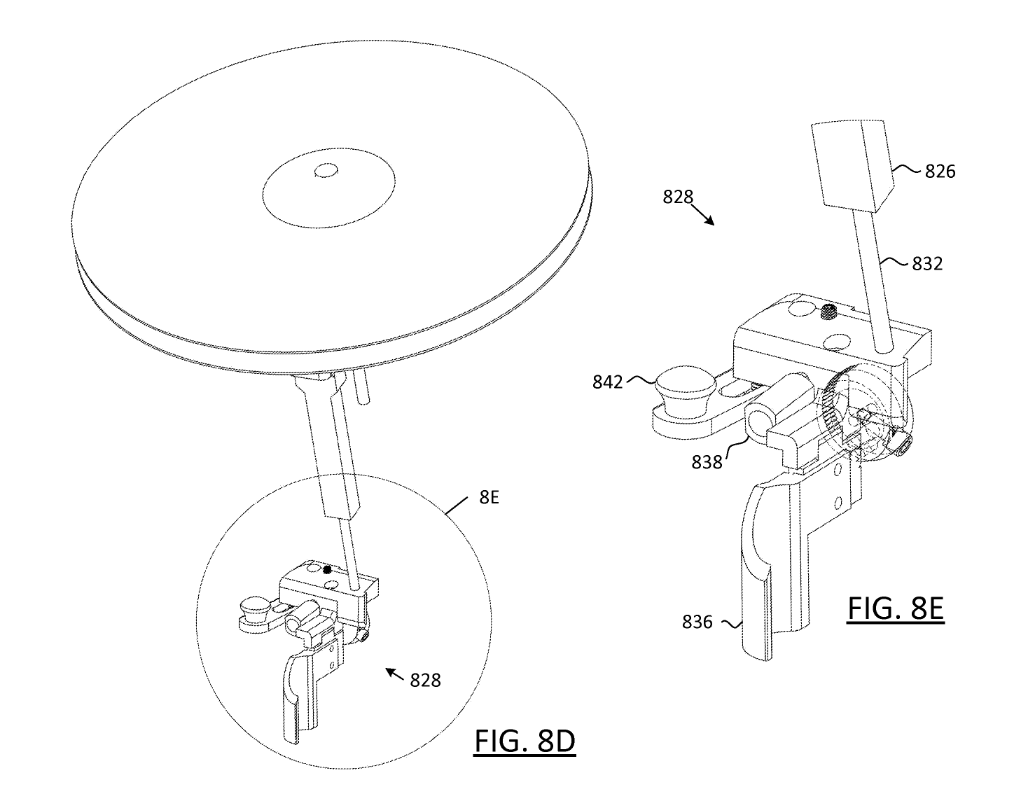

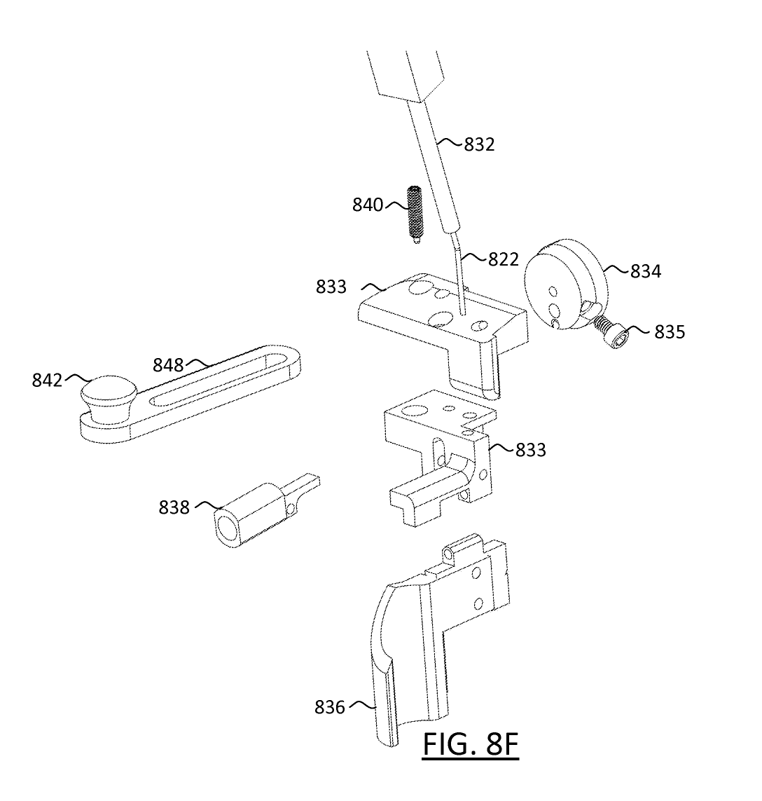

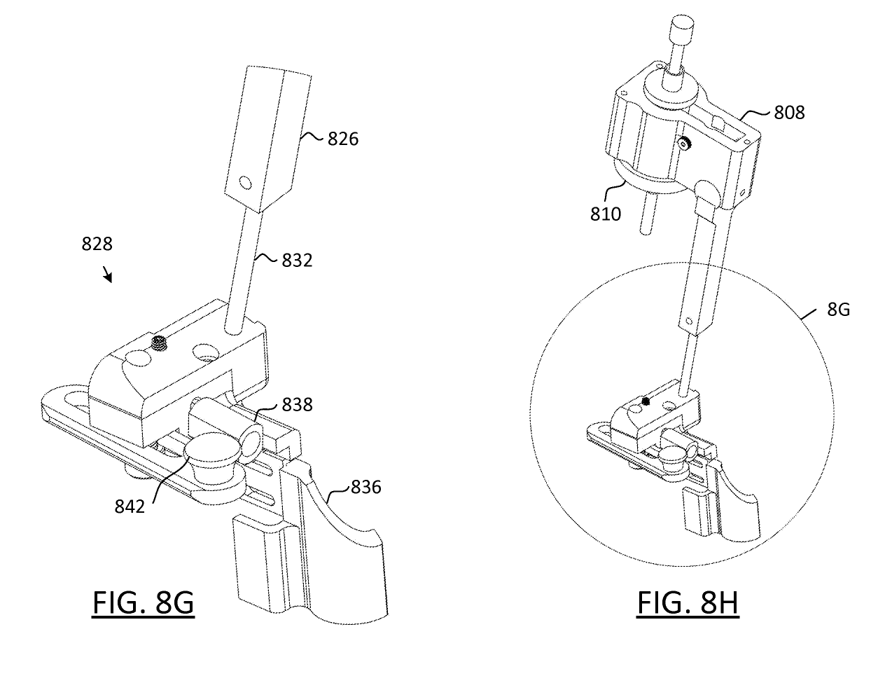

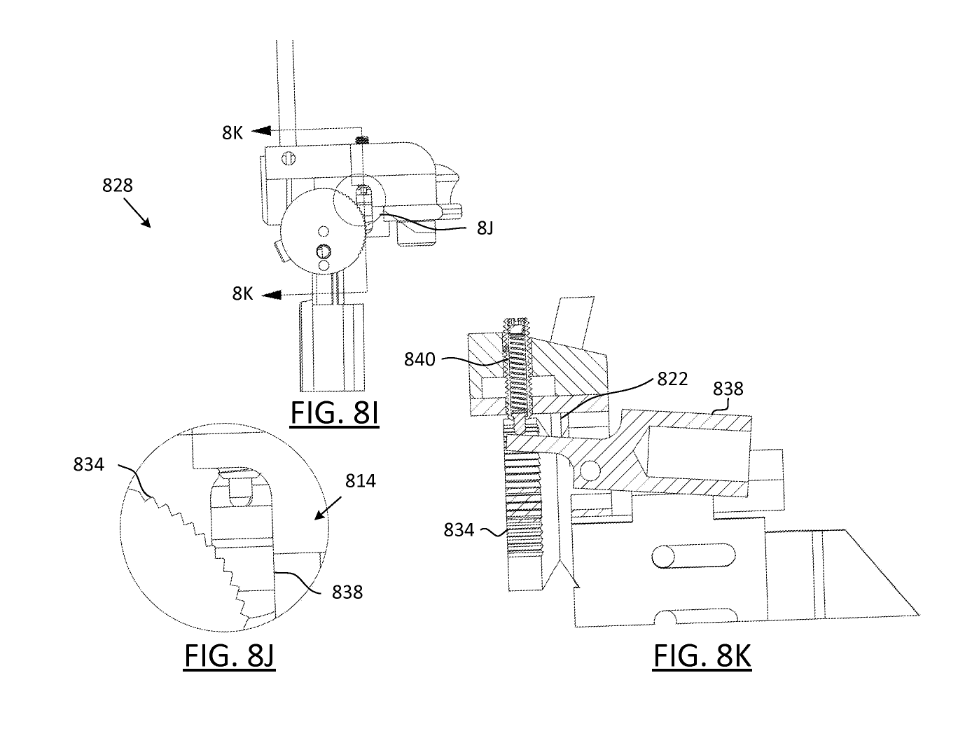

FIGS. 8A to 8K illustrate a hi-hat controller 800 having a cable actuator 812, in accordance with an embodiment. The hi-hat controller 800 mounts between a stand 810 (e.g. stand 12) and the lower hi-hat cymbal 802. The hi-hat controller 800 includes a shaft 806 (e.g. first body) for mounting to the lower hi-hat cymbal 802 and a housing 808 (e.g. second body) for mounting to the stand 810. The lower hi-hat cymbal 802 moves with the shaft 806 and the housing 808 remains stationary with respect to the stand 810.

The hi-hat controller 800 includes a cable actuator 812 for moving the shaft 806 with respect to the housing 808 and thus adjusting the space 816 between the lower hi-hat cymbal 802 and the upper hi-hat cymbal 804. The hi-hat controller 800 includes a remote control 828 for triggering the cable actuator 812 remotely from the hi-hat. In an embodiment, the hi-hat controller 800 includes a lock 814 for locking the position of the shaft 806 with respect to the housing 808.

The cable actuator 812 includes a housing arm 818 rotatably attached to the housing 808 about a pin 820 to move the shaft 806 up and down. A wire or cable 822 is attached at a first end to the housing arm 818 with a pivot pin 824 and passes through an extension arm 826. The cable 822 is attached at a second end to the remote control 828 of the hi-hat controller 800. A spring 830 in the housing 808 contacts the housing arm 818 and biases the housing arm 818 when the cable 822 is loosened.

FIGS. 8D to 8K show the remote control 828 in further detail. The remote control 828 includes control housing 833 The cable 822 passes through the extension arm 826 and into a flex housing 832. The flex housing 832 is flexible and attaches to the extension arm 826. The cable 822 is attached at a second end to a ratchet wheel 834 by fastener 835. The ratchet wheel 834 is rotatably attached to the control housing 833 and is controlled by a hinged arm 836. When the user actuates (e.g. closes) the hinged arm 836, the hinged arm 836 pulls the cable 822 around the ratchet wheel 834 and pivots the housing arm 818 to move the shaft 806 up.

In an embodiment, the ratchet wheel 834 sets the position of the cable 822 with the lock 814. The lock 814 includes a lock arm 838 which, as shown in FIGS. 8J and 8K, when engaged, is biased by a spring 840 to the ratchet wheel 834 for inhibiting movement of the ratchet wheel 834.

In use, the user's palm may rest on a button 842 and when the user desires to release the ratchet wheel 834 to bring the shaft 806 down, the user actuates the lock arm 838 and the ratchet wheel 834 is released. The user may also activate the hinged arm 836 while having the lock arm 838 pressed (to disengage the lock 814) so the user can open and close the lower hi-hat cymbal 802 and the upper hi-hat cymbal 804 as needed without locking the shaft 806 in any fixed position.

The extension arm 826 may be hinged with respect to the housing 608. The flex housing 832 and the hinged position of the extension arm 826 may allow the user to position the remote control 828 as desired. The user may position the remote control 828 such that the user is able to hit other percussion instruments while operating the hi-hat controller 800.

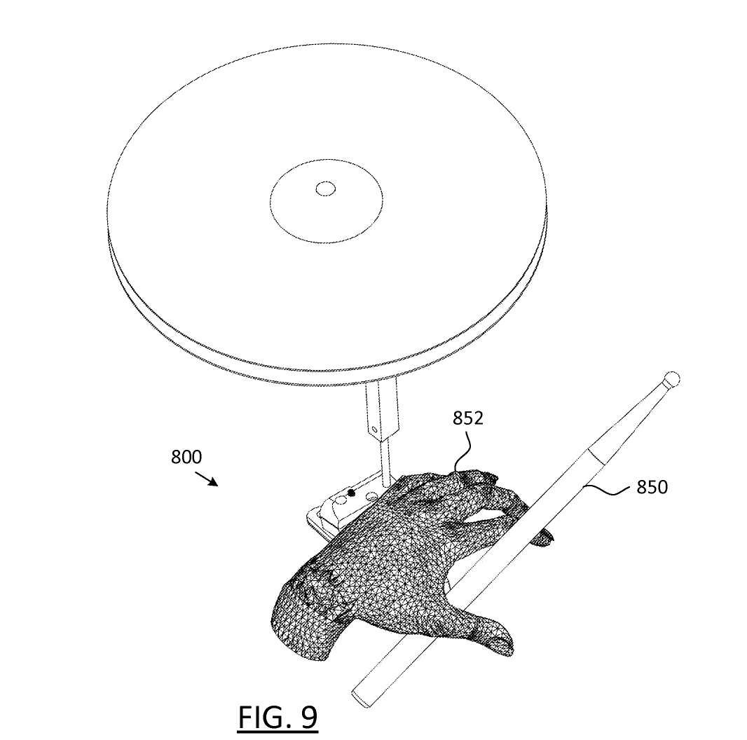

FIG. 9 illustrates the hi-hat controller 800 in use, in accordance with an embodiment. Fingers 852 of the user pull the hinged arm 836 to adjust the space 816. The hinged arm 836 may be adjustable in the control housing 833 such that it moves in and out from the control housing 833 to suit different sizes of hands. The button 842 may also be adjustably positioned with a slotted plate 848 (of FIG. 8F) that the button 842 is mounted with to the control housing 833. The cable 822 length may also be pulled in and out of the extension arm 826 and tightened to suit user preferences because of the variable location of the remote control 828.

In an embodiment, the space 816 between the lower hi-hat cymbal 802 and the upper hi-hat cymbal 804 may be adjusted by the user's hand 852. The user may be able to hold the drumstick 850 in the same hand 852 and hit other drums with the drumstick 850 within reach.

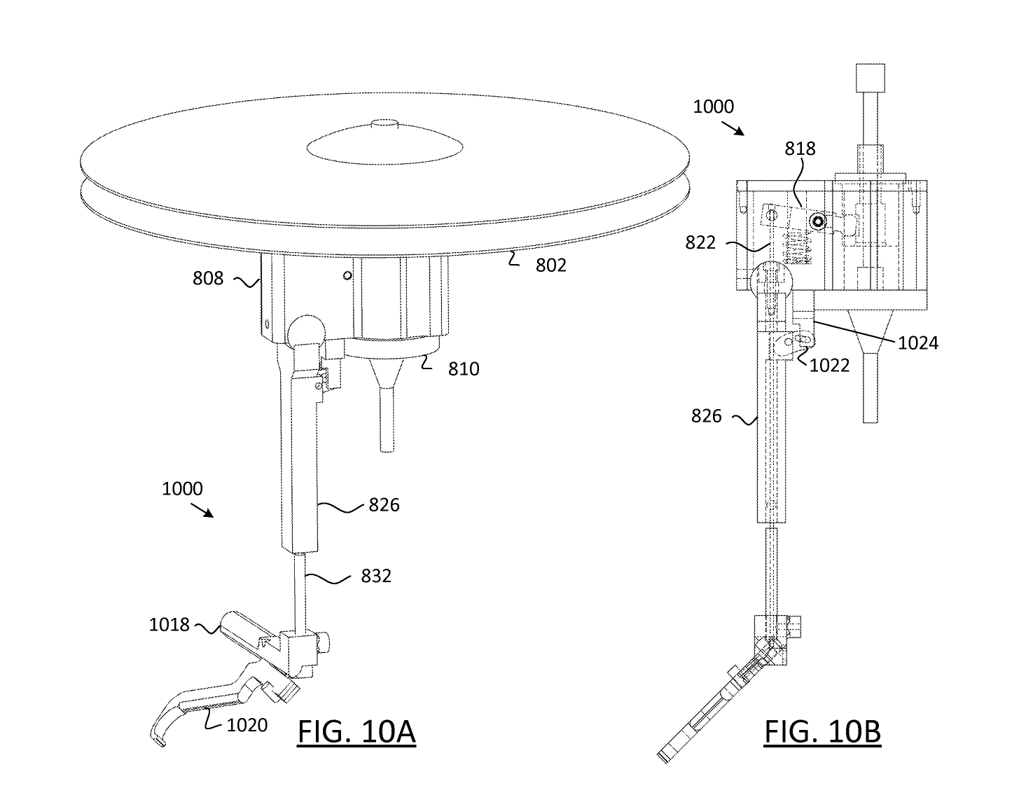

FIGS. 10A and 10B illustrate a hi-hat controller 1000, in accordance with a further embodiment. The hi-hat controller 1000 is similar to the hi-hat controller 800 of FIGS. 8A to 8C. The hi-hat controller 1000 actuates the cable 822 to activate the housing arm 818. The flex housing 832 attaches to a palm rest 1018 which hinges a trigger 1020. The cable 822 is attached to the trigger 1020. When the user pulls the trigger 1020, the cable actuates the housing arm 818.

The hi-hat controller 1000 may include a locking cam 1022. The locking cam 1022 tightens around the cable 822 when the extension arm 826 is pivoted with respect to the housing 808 towards the stand 810. A pin block 1024 is mounted to the housing 808 and controls the rotation of the locking cam 1022 to tighten or loosen the cable 822. When the extension arm 826 is pivoted away from the hi-hat controller 1000, the cable 822 loosens and unlocks the position of the lower hi-hat cymbal 802.

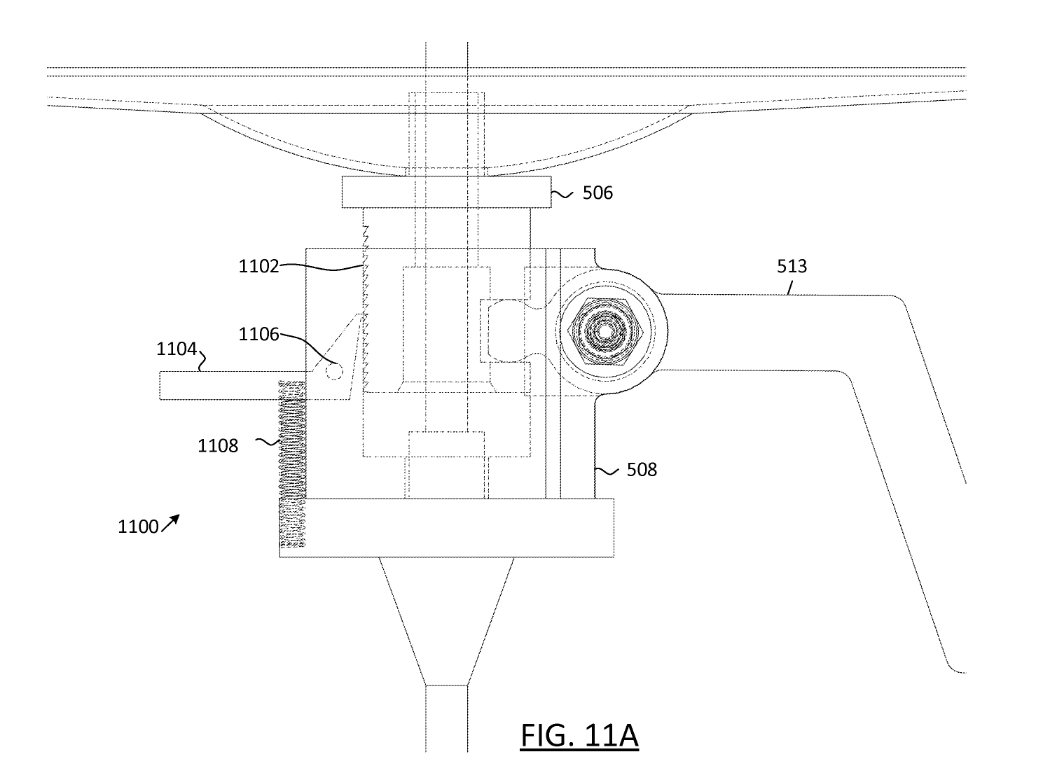

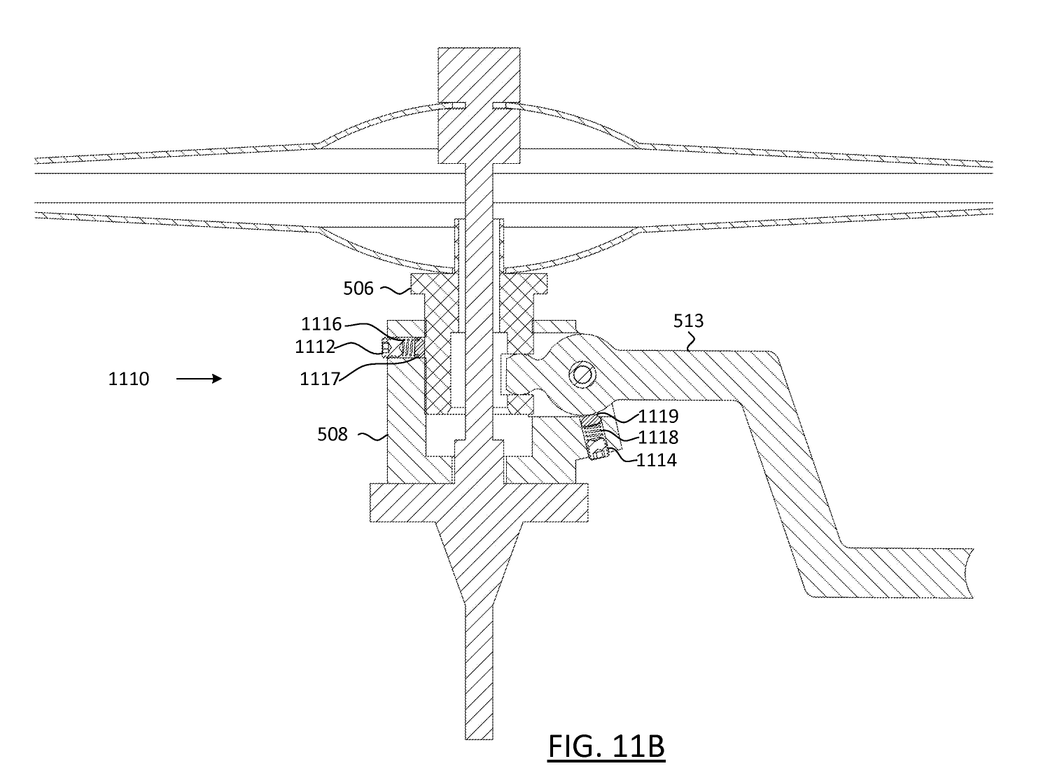

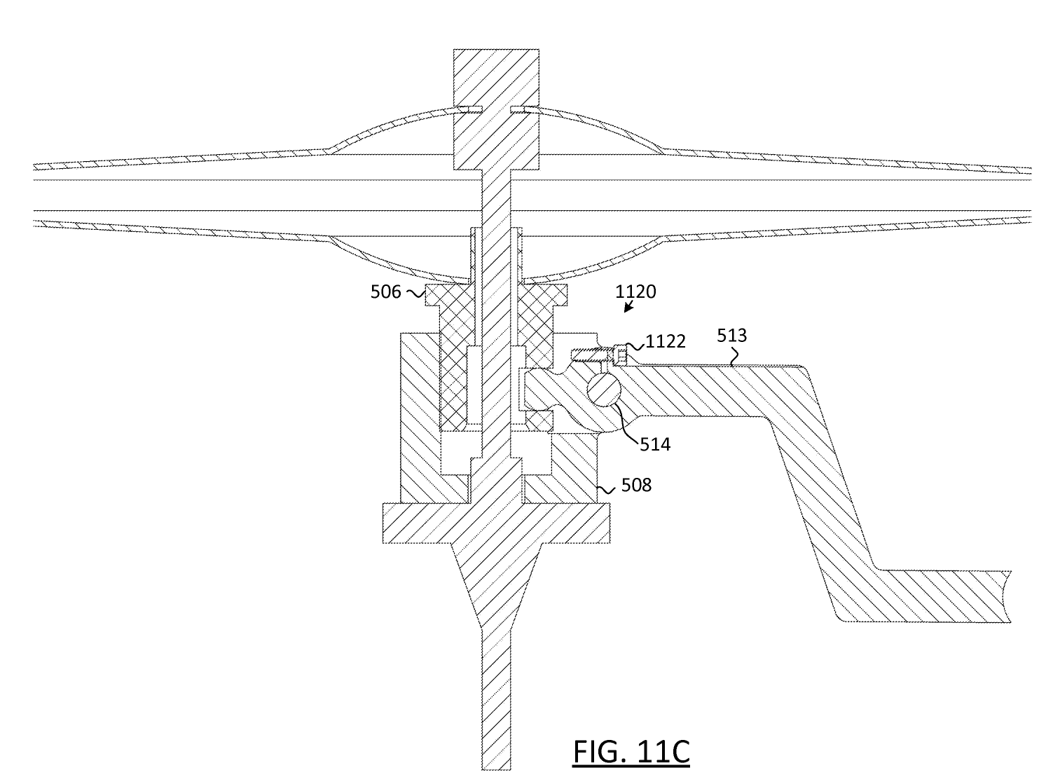

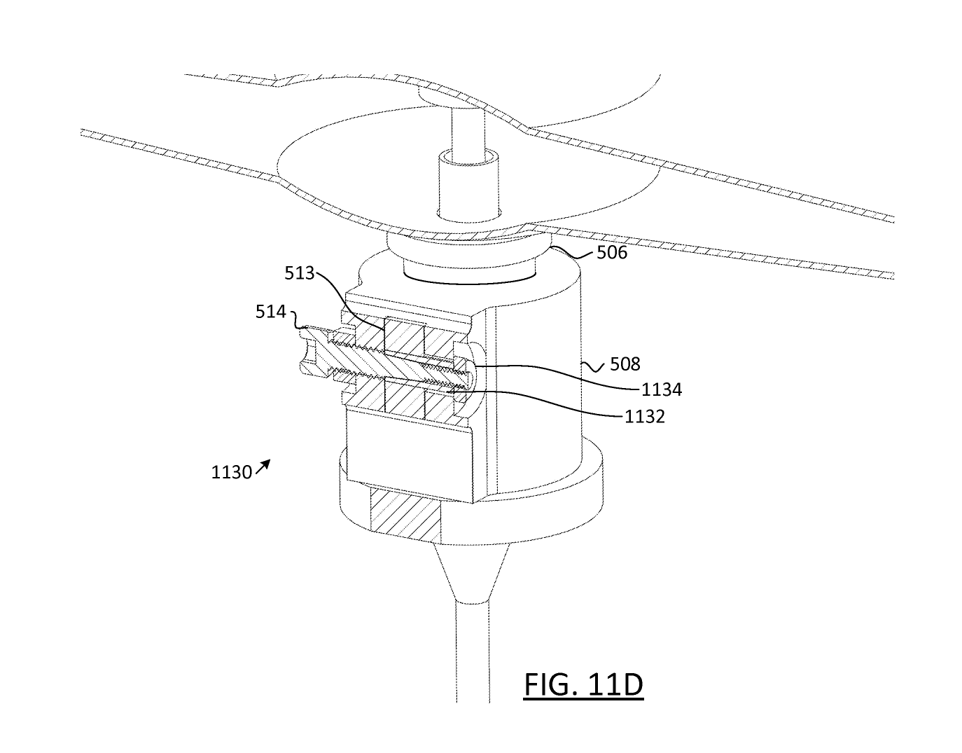

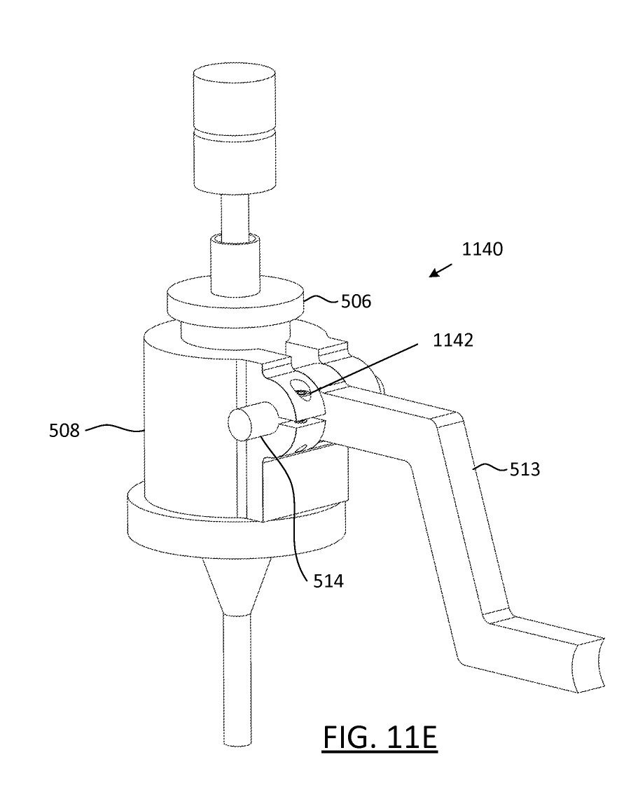

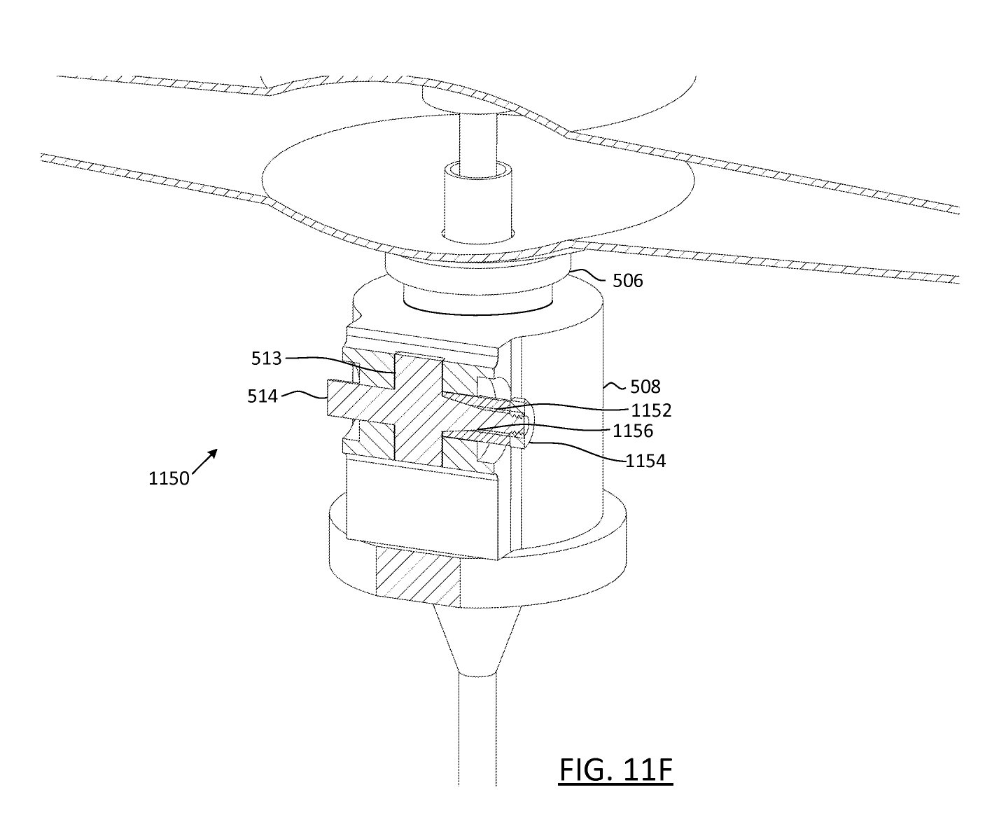

FIGS. 11A to 11F illustrate variant locks, for example with use by the hi-hat controller 500 of FIGS. 5A to 5D, in accordance with certain embodiments.

FIG. 11A illustrates a ratchet lock 1100. The ratchet lock 1100 includes a ratchet arm 1104 rotatably attached to the housing 508 and a plurality of ratchet grooves 1102 on the shaft 506. The plurality of ratchet grooves 1102 interact with the ratchet arm 1104 such that the shaft 506 can be raised with respect to the housing 508 when the adjustment arm 513 is actuated. When the ratchet arm 1104 is engaged with the ratchet grooves 1102, the ratchet arm 1104 sets the position of the shaft 506 and prevents the shaft 506 from lowering. The ratchet arm 1104 can be pivoted (at 1106) away from the shaft 506 by the user to disengage from the ratchet grooves 1102, and the shaft 506 can be unlocked and lowered. The ratchet arm 1104 may be biased by a spring 1108 towards the ratchet grooves 1102.

FIG. 11B illustrates a friction fastener lock 1110, in accordance with an embodiment. The friction fastener lock 1110 has a first friction screw 1112 that is forced on the shaft 506 and/or a second friction screw 1114 that forces on the adjustment arm 513. The first and second friction screws 1112, 1114 are threaded into the housing 508 such that the first and second friction screws 1112, 1114 can be tightened or loosened by a user to a desirable tension force to set the position of the shaft 506. The first friction screw 1112 may be a screw that tightens on the shaft 506 or it may be a screw that engages a spring 1116 which pushes a friction body 1117 on the shaft 506. Similarly, the second friction screw 1114 may be a screw that tightens on the adjustment arm 513 or it may be a screw that engages a spring 1118 which pushes a friction body 1119 which pushes on the adjustment arm 513.

FIG. 11C illustrates a pivot fastener lock 1120, in accordance with an embodiment. The pivot fastener lock 1120 includes a threaded fastener 1122 mounted in the adjustment arm 513. The threaded fastener 1122 tightens the adjustment arm 513 around the lock bolt 514 which is fixed in the housing 508, inhibited from rotating axially, to set the desired friction around the adjustment arm 513 and the lock bolt 514 to achieve the holding force to keep the shaft 506 from moving without engaging the adjustment arm 513.

FIG. 11D illustrates an expanding sleeve lock 1130, in accordance with an embodiment. The expanding sleeve lock 1130 includes a lock bolt 514 mounted and axially fixed in the housing 508, an expanding sleeve 1132 which expands, on the taper of the lock bolt 514, and a nut 1134, which when tightened, expands the expanding sleeve 1132. The expanding sleeve 1132 expands on the adjustment arm 513 to set the desired friction to achieve the holding force to keep the shaft 506 from moving without engaging the adjustment arm 513.

FIG. 11E illustrates a housing fastener lock 1140, in accordance with an embodiment. The housing fastener lock 1140 includes a threaded fastener 1142 that tightens the housing 508 around the lock bolt 514. The lock bolt 514 is integral and moves with the adjustment arm 513. The threaded fastener 1142 tightens the housing 508 to set the desired friction to achieve the holding force to keep the shaft 506 from moving without engaging the adjustment arm 513.

FIG. 11F illustrates an expanding sleeve lock 1150, in accordance with an embodiment. The expanding sleeve lock 1150 includes an expanding sleeve 1152 which expands, when the lock bolt 514 is tightened around a nut 1154. The lock bolt 514 is integral and moves with the adjustment arm 513. The lock bolt 514 includes a tapered shaft 1156 at the end for the nut 1154 which, when tightened, expands the expanding sleeve 1152 in the housing 508. The expanding sleeve 1152 expands on the housing 508 to set the desired friction to achieve the holding force to keep the shaft 506 from moving without engaging the adjustment arm 513.

While the above description provides examples of one or more apparatus, methods, or systems, it will be appreciated that other apparatus, methods, or systems may be within the scope of the claims as interpreted by one of skill in the art.

1. A hi-hat controller for controlling a space between a lower hi-hat cymbal and an upper hi-hat cymbal, the controller comprising:
a first body portion for coupling to the lower hi-hat cymbal;
a second body portion for coupling to a cymbal stand;
an actuator for moving the first body portion relative to the second body portion through a range of motion to adjust the space between the lower hi-hat cymbal and the upper hi-hat cymbal; and
a lock that automatically fixes the position of the first body portion with respect to the second body portion at any position along the range of motion when a user releases the actuator.

2. The hi-hat controller of claim 1 wherein the actuator comprises:
a handle attached to the first body portion and rotatable with respect to the second body portion, wherein the handle engages in a slot in the first body portion to move the first body portion.

3. The hi-hat controller of claim 2 wherein the lock includes a friction fit lock to hold the first body portion at the fixed position.

4. The hi-hat controller of claim 1 wherein the actuator comprises:
an adjustment arm mounted to and rotatably attached to the second body portion;
a first gear attached to the adjustment arm; and
a second gear mounted to and rotatably attached to the second body portion;
wherein the first gear rotatably engages the second gear and the second gear rotatably engages with a rack on the first body portion to move the first body portion.

5. The hi-hat controller of claim 4 wherein the lock includes a threaded fastener in the second body portion, a spring mounted to the threaded fastener, and a friction body mounted to the spring, wherein the friction body provides friction to any one or more of the first gear, the second gear, and the first body portion to fix the position of the first body portion.

6. The hi-hat controller of claim 1 wherein the actuator comprises an adjustment arm rotatably attached to the second body portion and engaging with a cavity in the first body portion, and wherein movement of the adjustment arm moves the first body portion.

7. The hi-hat controller of claim 6 wherein the lock comprises a lock bolt for compressing the second body portion around the first body portion to adjust the friction between the first body portion and the second body portion to hold the position of the first body portion.

8. The hi-hat controller of claim 7 wherein the adjustment arm includes a grooved stop to engage on the cavity to hold the lower hi-hat cymbal at an upmost position.

9. The hi-hat controller of claim 1 wherein the actuator comprises an adjustment arm rotatably attached to the second body portion and having a geared surface, wherein the geared surface mates with a rack gear on the first body portion.

10. The hi-hat controller of claim 9 wherein the lock comprises a lever rotatably attached to the adjustment arm, wherein the lever includes a ratchet point biased against ratchet notches in the second body portion, and wherein the ratchet notches and the ratchet point inhibit movement of the first body portion.

11. The hi-hat controller of claim 1 wherein the actuator comprises:
an adjustment arm rotatably attached to the second body portion, the adjustment arm having a pivot pin; and
a wedge slidably received in the second body portion, the wedge having an angled surface and a pivot slot for receiving the pivot pin;
wherein the pivot pin moves in the pivot slot to move the wedge laterally in the second body portion, and wherein the angled surface of the wedge slides on an angled surface of the first body portion to move the first body portion.

12. The hi-hat controller of claim 11 wherein the angled surface of the wedge frictionally engages with the angled surface of the first body portion to set the position of the first body portion.

13. The hi-hat controller of claim 1 wherein the actuator comprises:
a cable actuator for moving the first body portion with respect to the second body portion; and
a remote control for triggering the cable remotely from the hi-hat.

14. The hi-hat controller of claim 13 wherein the actuator further comprises:
a housing arm rotatably attached to the second body portion for moving the first body portion;
a cable attached at a first end to the housing arm and passing through an extension arm;
a spring in the second body portion for biasing the housing arm when the cable is loosened;
a ratchet wheel rotatably attached to the remote control and attached to a second end of the cable; and
a hinged arm attached to the ratchet wheel for controlling the ratchet wheel, wherein when the user actuates the hinged arm, the hinged arm pulls the cable around the ratchet wheel and pivots the housing arm to move the first body portion.

15. The hi-hat controller of claim 14 wherein the lock comprises a lock arm biased to the ratchet wheel for inhibiting movement of the ratchet wheel.

16. The hi-hat controller of claim 14 wherein the lock comprises a locking cam for tightening the cable when the extension arm is pivoted with respect to the second body portion.

17. The hi-hat controller of claim 6 wherein the lock comprises a ratchet arm rotatably attached to the second body portion and a plurality of ratchet grooves on the first body portion, wherein the plurality of ratchet grooves interact with the ratchet arm to set the position of the first body portion.

18. The hi-hat controller of claim 6 wherein the lock comprises at least one friction screw mounted in the second body portion, a spring mounted to the friction screw in the second body portion, and a friction body mounted to the spring, wherein the friction body provides frictional force to any one or more of the first body portion, the adjustment arm, or the second body portion to set the position of the first body portion.

19. The hi-hat controller of claim 6 wherein the lock comprises a threaded fastener mounted in the adjustment arm for tightening the adjustment arm around a lock bolt to set the friction to hold the position of the first body portion, wherein the lock bolt is fixed in the second body portion and inhibited from rotating axially.

20. The hi-hat controller of claim 6 wherein the lock comprises a lock bolt mounted and axially fixed in the second body portion, an expanding sleeve on the lock bolt operable to expand, and a nut on the lock bolt, which when tightened, expands the expanding sleeve, wherein the expanding sleeve expands on the adjustment arm to set the friction to hold the position of the first body portion.

21. The hi-hat controller of claim 6 wherein the lock comprises a threaded fastener for tightening the second body portion around a lock bolt to set the friction to hold the position of the first body portion, wherein the lock bolt is integral and moves with the adjustment arm.

22. The hi-hat controller of claim 6 wherein the lock comprises a lock bolt integral with the adjustment arm, an expanding sleeve on the lock bolt and operable to expand, and a nut on the lock bolt, which when tightened, expands the expanding sleeve, wherein the expanding sleeve expands on the second body portion to set the friction to hold the position of the first body portion.

23. The hi-hat controller of claim 6 wherein the lock comprises a lock bolt for compressing the second body portion around the adjustment arm to adjust the friction between the first body portion and the adjustment arm to hold the position of the first body portion.

24. The hi-hat controller of claim 6 wherein the lock comprises a threaded fastener and a nut for compressing the nut against the adjustment arm to adjust the friction between the nut and the adjustment arm to hold the position of the first body portion.
